(19) United States
(12) Patent Application Publication
(10) Pub. No.: US 2018/0233816 A1
(43) Pub. Date: Aug. 16, 2018

(54) VEHICLE COMMUNICATION APPARATUS AND METHOD

(71) Applicant: Jaguar Land Rover Limited, Coventry, Warwickshire (GB)

(72) Inventors: Phil BARBER, Coventry, Warwickshire (GB); Andrew FAIRGRIEVE, Coventry, Warwickshire (GB)

(21) Appl. No.: 15/748,522

(22) PCT Filed: Sep. 13, 2016
(86) PCT No.: PCT/EP2016/071541

§ 371 Date: Jan. 29, 2018

(30) Foreign Application Priority Data
Sep. 14, 2015 (GB) 1516197.9

(51) Int. Cl. H01Q 1/44; H04W 4/40; H04B 7/26

(52) U.S. Cl. CPC H01Q 1/44; H04B 7/2603; H04W 4/40

(57) ABSTRACT

The present disclosure relates to a vehicle (2) comprising an electrical device (4, 5, 6) having a primary function. In use, the electrical device (4, 5, 6) generates electromagnetic radiation while performing said primary function. A controller (7) is provided having at least one electronic processor (9) for receiving a data signal (S1). The at least one electronic processor (9) is configured to control operation of said electrical device (4, 5, 6) such that the generated electromagnetic radiation comprises a modulated signal (S_{MOD}) generated in dependence on said data signal (S1).

### TECHNICAL FIELD

The present disclosure relates to a vehicle communication apparatus and method. More particularly, but not exclusively, the present disclosure relates to a vehicle having a controller for controlling operation of an electric device to generate a modulated signal. The disclosure also relates to a controller for controlling an electric device to generate a modulated signal; and to a method of controlling an electric device to generate a modulated signal.

### BACKGROUND

Vehicle communication may be performed using conventional VHF and UHF transmissions when there is a line of sight (LOS) between the source vehicle and a target receiver. Thus, vehicle-to-vehicle (V2V) and vehicle-to-infrastructure (V2X) communication may be performed with relative ease. However, out of sight (OOS) communication is more problematic since VHF and UHF transmissions are attenuated by ground-based obstacles. Thus, communication may prove difficult when the vehicle is in mountainous terrain or a wooded area where there is no LOS. To overcome this problem, communication could be performed at medium wave (MW) bands since electromagnetic signals at these frequencies are less susceptible to attenuation due to ground-based obstacles. However, conventional (whip or dipole) medium wave transmission antennas are prohibitively large for mobile use. Magnetic antennas may be smaller (for example 1 m diameter), but are not ideal for use in a vehicle. This leaves a particular problem in medium distance vehicle-based communications, for example in the range 0.5 km to 10 km. This problem may be more significant for OOS communication, for example when a vehicle in a convoy is lost or disabled.

At least in certain embodiments, the present invention seeks to provide a vehicle-based wireless communication system which overcomes or ameliorates at least some of the problems associated with known communication systems.

### SUMMARY OF THE INVENTION

Aspects of the present invention relate to a controller, to a vehicle and to a method of controlling an electrical device to generate a modulated signal.

According to a further aspect of the present invention there is provided a controller for controlling operation of an electrical device having a primary function, wherein electromagnetic radiation is generated by the electrical device while performing said primary function, the controller comprising: at least one electronic processor for receiving a data signal; a memory device coupled to the electronic processor and having instructions stored therein; wherein the at least one electronic processor is configured to output a control signal for controlling operation of the electrical device such that the generated electromagnetic radiation comprises a modulated signal generated in dependence on said data signal.

The magnetic field induced by the high currents in the electrical device may be used to transmit the modulated signal. The primary function of the electrical device is not to generate electromagnetic radiation. Rather, the electromagnetic radiation is generated as a by-product or side-effect of the electric device performing its primary function. By controlling operation of the electrical device, the controller may utilise the electrical device also to function as a modulated signal transmitter. Thus, the controller enables the electrical device to be controlled to provide a secondary function. The modulated signal conveys information, for example in the form of a coded signal.

The controller may be in the form of a modulator.

The controller may receive the data signal from an input device, such as one or more switch, a microphone, a keyboard etc. The data signal may be generated dynamically by one or more vehicle systems, such as a Global Positioning System (GPS) and/or vehicle attitude sensors. Alternatively, the data signal may be a predefined signal, for example stored in the memory device.

The modulated signal may provide vehicle-to-vehicle (V2V) communication; and/or vehicle-to-infrastructure (V2X) communication.

The modulated signal may be controlled so as to reflect off the ionosphere to provide extended coverage. This type of communication is known as Near Vertical Incidence Skywave (NVIS). The modulated signal may be transmitted at a frequency up to a Maximum Usable Frequency (MUF) for Skywave. The MUF may vary depending on conditions, and may change depending on the time of day (for example, changing for transmissions made during the day or at night).

The modulated signal may be transmitted at a very high frequency (VHF), for example 30 MHz to 300 MHz. The modulated signal may be transmitted at a frequency less than or equal to 2 MHz. For example, the modulated signal may be transmitted in a medium wave (MW) band. The MW band may penetrate ground-based obstacles and may be reflected off the ionosphere to provide increased coverage

The at least one electronic processor may be configured to selectively activate and deactivate the electrical device to generate said modulated signal. The at least one electronic processor may be configured to control an operating mode of the electrical device to generate said modulated signal.

The at least one electronic processor may be configured to change one or more operating parameter of the electrical device to modify the properties of the electromagnetic radiation generated by the electrical device for transmission purposes. The at least one electronic processor may be configured to change one or more operating parameter of the electrical device to increase the amplitude of the electromagnetic signal when generating said modulated signal.

When providing said primary function, control strategies may be implemented to reduce the electromagnetic radiation generated by the electrical device. The at least one processor may inhibit or suppress these control strategies for transmission purposes. The at least one processor may be operable to enable these control strategies when transmission of the modulated signal is not required, and/or to inhibit or suppress these control strategies in the event that transmission of the modulated signal is required. Transmission of the modulated signal may be required in an emergency event, or wherein a vehicle in which the controller may be implemented is out of range of other known communication means, such as a telecommunication means, for example.

The at least one electronic processor may be configured to change one or more operating parameter of the electrical device to adjust the frequency of the electromagnetic signal when generating said modulated signal.

The at least one electronic processor may be configured to control the electrical device to vary the amplitude and/or frequency and/or phase of the transmitted electromagnetic radiation to generate the modulated signal.

The electrical device may be one of the following: a front windshield heater; a rear windshield heater; an alternator; a light, such as a headlamp; or an electric traction machine.

The data signal may comprise an emergency signal. The controller may thereby control the electrical device to provide an emergency beacon function.

According to a further aspect of the invention there is provided a vehicle comprising: an electrical device having a primary function, the electrical device generating electromagnetic radiation while performing said primary function; and a controller of any preceding aspect of the invention. The at least one electronic processor is configured to control operation of said electrical device such that the generated electromagnetic radiation comprises a modulated signal generated in dependence on said data signal.

The magnetic field induced by the high currents in the electrical device may be used to transmit the modulated signal. The primary function of the electrical device is not to generate electromagnetic radiation. Rather, the electromagnetic radiation is generated as a by-product or side-effect of the electric device performing its primary function. By controlling operation of the electrical device, the controller may utilise the electrical device also to function as a modulated signal transmitter. Thus, the controller enables the electrical device to be controlled to provide a secondary function. The modulated signal conveys information, for example in the form of a coded signal.

According to a further aspect of the present invention there is provided a vehicle comprising an electrical device having a primary function, the electrical device generating electromagnetic radiation while performing said primary function. The vehicle may comprise a controller having at least one electronic processor for receiving a data signal. The vehicle may comprise a memory device coupled to the electronic processor and having instructions stored therein. The at least one electronic processor may be configured to control operation of said electrical device such that the generated electromagnetic radiation comprises a modulated signal generated in dependence on said data signal.

According to a further aspect of the present invention there is provided a method of controlling an electrical device having a primary function, wherein electromagnetic radiation is generated by the electrical device while performing said primary function, the method comprising:
receiving a data signal;
generating a control signal in dependence on said data signal; and
outputting said control signal to control operation of the electrical device such that the electromagnetic radiation generated by the electrical device comprises a modulated signal.

The method may comprise selectively activating and deactivating the electrical device to generate said modulated signal. The method may comprise controlling an operating mode of the electrical device to generate said modulated signal.

The method may comprise changing one or more operating parameter of the electrical device to modify the properties of the electromagnetic radiation generated by the electrical device when generating said modulated signal. The method may comprise changing one or more operating parameter of the electrical device to change the amplitude of the electromagnetic signal when generating said modulated signal. The change may comprise increasing or decreasing the amplitude of the electromagnetic signal. The change can, for example, be implemented to ensure that the transmission complies with legislative requirements, for example relating to electromagnetic compatibility (EMC) thresholds. The method may comprise changing one or more operating parameter of the electrical device to adjust the frequency of the electromagnetic signal when generating said modulated signal.

The method may comprise controlling the electrical device to vary the amplitude and/or frequency of the transmitted electromagnetic radiation to generate the modulated signal.

The data signal may comprise an emergency signal. For example, the data signal may comprise an SOS message or the like. The data signal could optionally comprise location information, for example derived from a global positioning system.

The modulated data signal may be received and decoded by a receiver. The receiver may be in the form of a software-defined radio (SDR) having functionality which is configured using software or programmable hardware. The SDR hardware may communicate at different frequencies using different wireless standards or a proprietary standard.

According to a further aspect of the present invention there is provided a non-transitory computer readable media comprising a set of instructions. When executed by an electronic processor, the instructions cause the electronic processor to implement the method(s) described herein.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment may be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a vehicle incorporating a wireless communication system in accordance with an embodiment of the present invention; and

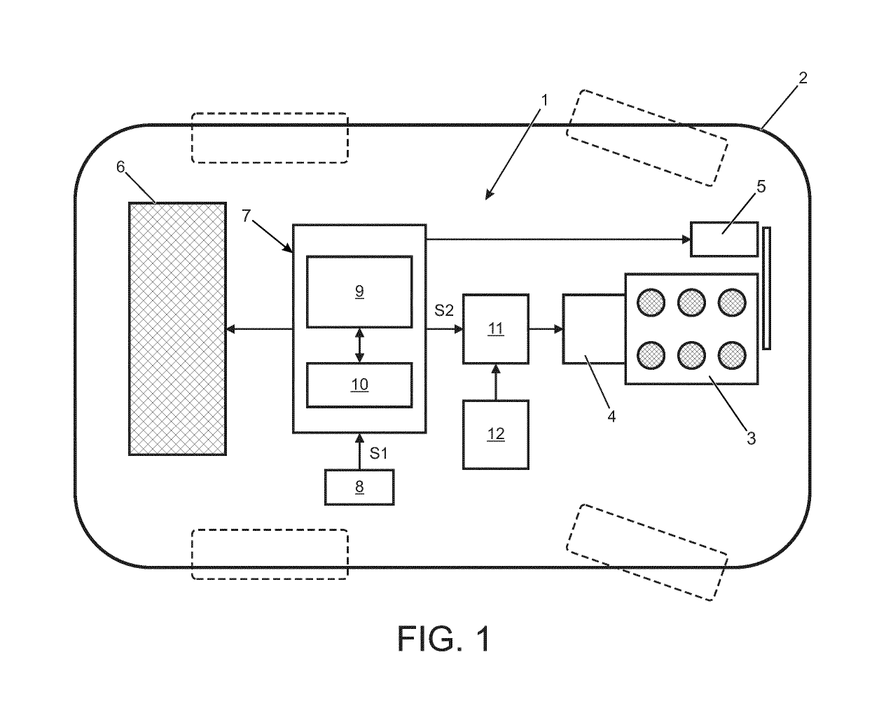

FIG. 2 shows a schematic representation of operation of the wireless communication system in accordance with an embodiment of the present invention.

### DETAILED DESCRIPTION

A wireless communication system 1 in accordance with an embodiment of the present invention will now be described. The wireless communication system 1 is intended for use in a first vehicle 2. The first vehicle 2 in the present embodiment is an off-road vehicle, such as a utility vehicle or a sports utility vehicle (SUV), comprises an internal combustion engine 3. It will be appreciated that the wireless communication system 1 may be implemented in other types of vehicle.

The first vehicle 2 includes a plurality of on-board electrical systems each having a dedicated primary function. When the on-board electrical systems are energized to perform their respective primary functions, electromagnetic radiation is generated. As described herein, the wireless communication system 1 is configured to control operation of one or more of said electrical system to generate an electromagnetic signal comprising a modulated signal S_{MOD}. In the present embodiment, the on-board electrical systems include an electric traction machine 4, an alternator 5 and a windshield heater 6. The electric traction machine 4 forms part of the vehicle drivetrain and has a primary function of generating a tractive force to propel the first vehicle 2. The wireless communication system 1 is configured to control operation of the electric traction machine 4 to generate the modulated signal S_{MOD}. The electric traction machine 4 is thereby operated to provide a secondary function.

The wireless communication system 1 comprises a modulator 7 for receiving a data signal S1 from one or more input device 8. The input device 8 may be a microphone for generating an audio signal; or a global positioning system (GPS) for providing geographic location information. The modulator 7 comprises at least one first electronic processor 9 connected to one or more memory device 10. A set of computational instructions is stored on said memory device 10. When executed, the computational instructions cause the at least one first electronic processor 9 to output a control signal S2 to a commutation controller (inverter) 11. The at least one first electronic processor 9 may implement a low bandwidth communication protocol, such as PSK31 or WSPR, to convert the data signal S1 into a coded signal embedded in the control signal S2. A proprietary communication protocol could be implemented using suitably configured encoders and decoders.

The commutation controller 11 is connected to the electric traction machine 4 and to an energy storage device 12 in the form of a battery. The commutation controller 11 controls the supply of electrical energy from the energy storage device 12 to the electric traction machine 4. When the electric traction machine 4 is energised to perform its primary function, electromagnetic radiation is generated. The electromagnetic radiation is a by-product of operating the electric traction machine 4. By controlling operation of the commutation controller 11 in dependence on the control signal S2, the wireless communication system 1 utilises the generated electromagnetic radiation to generate the modulated signal S_{MOD}. One or more of the amplitude, frequency and phase of the electromagnetic radiation is varied in dependence on the data signal S1 to generate the modulated signal S_{MOD}.

The wireless communication system 1 may be configured to modify one or more operating parameters of the electric traction machine 4 and/or the modulator 7 when transmitting the modulated signal S_{MOD}. The generated electromagnetic radiation may cause interference, for example with wireless communication systems. It is known to use specific techniques for reducing electromagnetic radiation generated from electric circuits, such as dithering Pulse Width Modulation (PWM) signals and softening edges of digital signals such as may bus wiring. Similarly, control strategies may be implemented to reduce the emission of electromagnetic radiation by the electric traction machine 4. The at least one first electronic processor 9 is configured to control the commutation controller 11 to alter one or more operating parameter of the electric traction machine 4 to modify the modulated signal S_{MOD}. For example, the control strategies implemented by the commutation controller 11 to reduce the electromagnetic radiation generated when the electric traction machine 4 performs its primary function may be inhibited or suppressed by the modulator 7 when the electric traction machine 4 is used to transmit the modulated signal S_{MOD}. Indeed, one or more operating parameters of the electric traction machine 4 and/or the modulator 7 may be modified to increase the electromagnetic radiation generated for transmission purposes. By changing the operation of the electric traction machine 4, the power of the modulated signal S_{MOD} may be changed, for example to boost the transmission range. Alternatively, or in addition, operation of the electric traction machine 4 may be controlled to generate electromagnetic radiation at a specific frequency for transmission purposes.

The modulated signal S_{MOD} is transmitted at a frequency in a medium wave (MW) band or below (less than approximately 2 MHz). The MW band in Europe ranges from 526.5 kHz to 1606.5 kHz, using channels spaced every 9 kHz. The MW band in North America ranges from 535 kHz to 1705 kHz, using 10 kHz spaced channels. The inherent electromagnetic properties allow the modulated signal S_{MOD} to be transmitted over long distances. The modulated signal S_{MOD} may penetrate ground obstacles (denoted generally by a reference numeral 13). In favourable conditions, the modulated signal S_{MOD} may reflect off the ionosphere to provide extended coverage (provided the receiver has sufficient selectivity). This type of communication is known as Near Vertical Incidence Skywave (NVIS). The bandwidth is restricted and this limits the achievable data exchange rate, for example the PSK31 protocol allows baud rates of 31 (bits per second) and below.

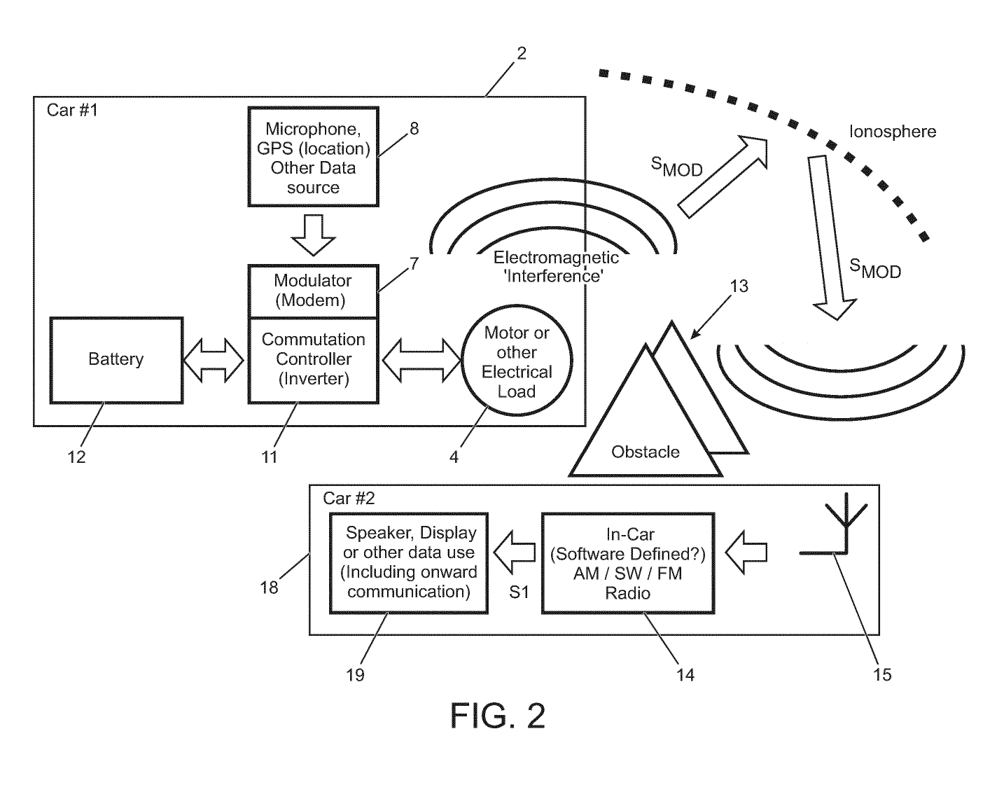

As shown in FIG. 2, the modulated signal S_{MOD} is received by a receiver 14. The receiver 14 comprises at least one second electronic processor (not shown) and a second memory device (not shown). The receiver 14 is connected to an antenna 15 configured to receive medium wave (MW) band transmissions. A set of computational instructions is stored on the second memory device. When executed, the computational instructions cause the second memory device to decode the modulated signal S_{MOD}. The modulated signal S_{MOD} is received by the receiver 14 and decoded by the at least one second electronic processor to extract the information from the one or more input device 8. The receiver 14 may be a dedicated unit or may be incorporated into a radio receiver, for example a medium wave (AM) tuner. The decoding software may be implemented on a software controlled tuner. The PSK31 low bandwidth communication protocol may decipher the modulated signal S_{MOD} from the noise base. In the present embodiment, the receiver 14 is incorporated into a second vehicle 18 to enable vehicle-to-vehicle (V2V) communication. The receiver 14 is coupled to output means 19 for outputting the decoded signal. The output means 19 can, for example, comprise a loudspeaker or a display. Alternatively, the output means 19 may provide alternate data usage, for example onward transmission of the signal. It will be understood that the wireless communication system 1 may also provide vehicle-to-infrastructure (V2X) communication, for example to communicate with a base station or fixed receiver.

The operation of the wireless communication system 1 will now be described. The input device 8 is used to generate the data signal S1. The at least one first electronic processor 9 converts the data signal S1 into a coded signal which is embedded in the control signal S2 output to the commutation controller 11. The commutation controller 11 controls the electric traction machine 4 in dependence on the control signal S2. In particular, the commutation controller 11 activates the electric traction machine 4 such that the electromagnetic radiation generated forms the modulated signal S_{MOD}. The modulated signal S_{MOD} is received by the receiver 14 and decoded by the at least one second electronic processor. The information conveyed by the data signal S1 is thereby transmitted as a function of operation of the electric traction machine 4.

The wireless communication system 1 may operate when the first vehicle 2 is stationary. The vehicle driveline may be configured to disengage the electric traction machine 4 such that a tractive force is not transmitted to the drive wheels. For example, a clutch disposed in the vehicle driveline may be operated to disengage the electric traction machine 4. Alternatively, or in addition, the wireless communication system 1 may operate when the first vehicle 2 is moving. The first vehicle 2 could utilise the internal combustion engine to provide a tractive force and activate the electric traction machine 4 to generate the modulated signal S_{MOD}. Alternatively, the electric traction machine 4 may generate a tractive force whilst generating the modulated signal S_{MOD}. The control signal S2 may be configured to modify an operating mode or characteristic of the electric traction machine 4 to generate the modulated signal S_{MOD}.

The wireless communication system 1 has particular application in operating as an emergency beacon to transmit an emergency signal. By transmitting the modulated signal S_{MOD} in the medium wave (MW) band, the wireless communication system 1 may provide OOS communications with the second vehicle 18 or infrastructure. The emergency signal may be a coded signal, for example using Morse code to transmit and SOS signal, or may comprise an audio signal.

The wireless communication system 1 has been described as a transmitter. It will be appreciated that the wireless communication system 1 may comprise a receiver to enable two-way communication. The receiver 14 could be duplicated in the first vehicle 2. The receiver 14 can, for example, be incorporated into a tuner in the first vehicle 2.

It will be appreciated that various changes and modifications may be made to the wireless communication system 1 described herein without departing from the scope of the present invention. For example, the input device 8 could be a cellular telephone connected to the first vehicle 2 over a wireless network, such as a Bluetooth (RTM) coupling.

The wireless communication system 1 has been described as controlling the electric traction machine 4 to generate the modulated signal S_{MOD}. It will be appreciated that other electrical systems on the first vehicle 2 may be activated to generate the modulated signal S_{MOD}. For example, the modulator 7 may be configured to control the vehicle alternator, heated windshield to generate the modulated signal S_{MOD}. In certain embodiments, more than one of said electrical systems may be operated to generate the modulated signal S_{MOD}.

The wireless communication system 1 may be activated by a user, for example by activating an emergency beacon. Alternatively, or in addition, the wireless communication system 1 could be activated automatically, for example in the event of a vehicle system detecting a collision.

1. A controller for controlling operation of an electrical device having a primary function, wherein electromagnetic radiation is generated by the electrical device as a side-effect of performing the primary function, the controller comprising at least one electronic processor for receiving a data signal;
wherein the at least one electronic processor is configured to output a control signal to control operation of the electrical device such that the electromagnetic radiation generated as a side-effect of performing the primary function comprises a modulated signal generated in dependence on the data signal.

2. The controller as claimed in claim 1, wherein the at least one electronic processor is configured to selectively activate and deactivate the electrical device to generate the modulated signal.

3. The controller as claimed in claim 1, wherein the at least one electronic processor is configured to control an operating mode of the electrical device to generate the modulated signal.

4. The controller as claimed in claim 1, wherein the at least one electronic processor is configured to change one or more operating parameter of the electrical device to modify properties of the electromagnetic radiation generated by the electrical device when generating the modulated signal.

5. The controller as claimed in claim 4, wherein the at least one electronic processor is configured to change the one or more operating parameter of the electrical device to change an amplitude of the electromagnetic radiation when generating the modulated signal.

6. The controller as claimed in claim 4, wherein the at least one electronic processor is configured to change the one or more operating parameter of the electrical device to adjust a frequency of the electromagnetic radiation when generating the modulated signal.

7. The controller as claimed in claim 1, wherein the at least one electronic processor is configured to control the electrical device to vary an amplitude and/or frequency and/or phase of the electromagnetic radiation to generate the modulated signal.

8. The controller as claimed in claim 1, wherein the electrical device is one of the following: a front windshield heater; a rear windshield heater; an alternator; a light; or an electric traction machine.

9. The controller as claimed in claim 1, wherein the data signal comprises an emergency signal.

10. A vehicle comprising:
an electrical device having a primary function, wherein the electrical device generates electromagnetic radiation while performing the primary function; and
a controller as claimed in claim 1;
wherein the at least one electronic processor is configured to control operation of the electrical device such that the generated electromagnetic radiation comprises a modulated signal generated in dependence on the data signal.

11. A method of controlling an electrical device having a primary function, wherein electromagnetic radiation is generated by the electrical device as a side-effect of performing the primary function, the method comprising:
receiving a data signal;
generating a control signal in dependence on the data signal; and
outputting the control signal to control operation of the electrical device such that the electromagnetic radiation generated by the electrical device as a side-effect of performing the primary function comprises a modulated signal.

12. The method as claimed in claim 11, further comprising selectively activating and deactivating the electrical device to generate the modulated signal.

13. The method as claimed in claim 11, further comprising controlling an operating mode of the electrical device to generate the modulated signal.

14. The method as claimed in claim 11, further comprising changing one or more operating parameter of the electrical device to modify properties of the electromagnetic radiation generated by the electrical device when generating the modulated signal.

15. The method as claimed in claim 14, further comprising changing one or more operating parameter of the electrical device to change an amplitude of the electromagnetic radiation when generating the modulated signal.

16. The method as claimed in claim 14, further comprising changing one or more operating parameter of the electrical device to adjust a frequency of the electromagnetic radiation when generating the modulated signal.

17. The method as claimed in claim 11, further comprising controlling the electrical device to vary an amplitude and/or frequency and/or phase of the transmitted electromagnetic radiation to generate the modulated signal.

18. The method as claimed in claim 11, wherein the data signal comprises an emergency signal.

19-21. (canceled)

22. The method as claimed in claim 11, further comprising:
enabling control strategies to reduce the electromagnetic radiation generated by the electrical device when not controlling operation of the electrical device to generate the modulated signal; and
inhibiting the control strategies which reduce the electromagnetic radiation generated by the electrical device when controlling operation of the electrical device to generate the modulated signal.

23. The controller as claimed in claim 1, wherein the at least one electronic processor is operable to enable control strategies to reduce the electromagnetic radiation generated by the electrical device when not outputting the control signal to control operation of the electrical device to generate the modulated signal; and
to inhibit the control strategies which reduce the electromagnetic radiation generated by the electrical device when outputting the control signal to control operation of the electrical device to generate the modulated signal.
